(19) United States
(12) Patent Application Publication
(10) Pub. No.: US 2013/0084934 A1
(43) Pub. Date: Apr. 4, 2013

(54) AMUSEMENT APPARATUS

(71) Applicant: George Young, Walnut, CA (US)

(72) Inventor: George Young, Walnut, CA (US)

(21) Appl. No.: 13/626,794

(22) Filed: Sep. 25, 2012

Related U.S. Application Data
(63) Continuation-in-part of application No. 12/239,560, filed on Sep. 26, 2008.
Application No. 12/239,560 is a continuation-in-part of application No. 12/032,524, filed on Feb. 15, 2008, now abandoned.
(60) Provisional application No. 60/890,187, filed on Feb. 15, 2007.

(51) Int. Cl. G07F 17/32

(52) U.S. Cl. CPC G07F 17/3293
USPC 463/16

(57) ABSTRACT

An entertainment apparatus may include an arcade game; a video display device in communication with said arcade game; an electronic game module in communication with said video display device and, comprising a processor; a computer readable medium in communication with said processor; microcode encoded in said computer readable medium, wherein said processor utilizes said microcode to operate said game module; instructions written to said computer readable medium; and a music playing unit that is used to play music from either at least one music database in the entertainment apparatus or a communication network connected to a plurality of music content sources. In one embodiment, the gaming apparatus is able to search a player's social networking websites through the communication network to further determine the player's preference about music, and retrieve the music from the music database in the entertainment apparatus or the communication network connected to music content sources.

### CROSS REFERENCE TO RELATED APPLICATIONS

This application is a continuation-in-part of U.S. application Ser. No. 12/239,560 (the '560 Application) filed on Sep. 26, 2008 entitled “ARCADE GAME IN COMBINATION WITH AN ELECTRONIC GAME OF CHANCE” to George Young and this application claims priority under 35 U.S.C. 120 to the '560 Application, which is also a continue-in-part of U.S. application Ser. No. 12/032,524 (the '524 Application) filed Feb. 15, 2008 entitled “Apparatus and Method for Providing a Game of Chance at a Point of Sale” to George Young, and the '524 Application claimed priority under 35 U.S.C. 119 from a U.S. Provisional Application having Ser. No. 60/890,187, filed Feb. 15, 2007.

The U.S. Non-Provisional Applications having Ser. Nos. 12/239,560 and 12/032,524 are hereby incorporated by reference herein. The U.S. Provisional Application having Ser. No. 60/890,187 is hereby incorporated by reference herein.

### FIELD OF THE INVENTION

This invention relates to an apparatus and method for providing a game of chance at point of sale. In certain embodiments, the invention relates to an arcade game interfaced with an electronic game of chance. In certain embodiments, the invention relates to a medal game, sometimes referred to as a “coin pusher” interfaced with an electronic game of chance. In further embodiment, the invention relates to a “coin pusher” interfaced with an electronic game of chance that can be used as a jukebox to play music for the user.

### BACKGROUND OF THE INVENTION

Arcade games that measure a player's skill and luck are well known in the art. These types of games generally dispense tickets or tokens to a winning player who can redeem the tickets for a prize at a redemption center. Owners of arcade games have utilized a wide variety of methods to encourage persons to play certain entertainment games. It is known in the art to offer certain incentives, i.e. “loss leaders,” to entice players to patronize an entertainment center. Hopefully, those players will elect to play additional arcade games in addition to the loss leader products.

U.S. Pat. No. 6,550,768 to Jordan et al. (hereinafter “Jordan”) discloses a skill-based game employing kickers to direct coins falling over the edge of a catcher plate to a player's hopper. The player's deposit coins in a slot which directs the coins to a first catcher plate. Coins are pushed over the edge of this catcher plate to a second catcher plate where they are further pushed forward the edge of the second catcher plate. If the player employs the kicker correctly, the coins falling over the edge of the second catcher plate are directed to a player's hopper. Otherwise, the coins fall into a hopper and are retained by the machine. However, Jordan does not disclose a “profit regiter” that can automatically count the number of coins in the player's hopper and help the player understand whether he/she is winning or not. Also, while the player is playing, he/she may need some music to be more entertained. Jordan does not disclose the gaming machine with music that can be selected by the players.

U.S. Pat. Pub. No.: 20050124281 to Marchini et al. (hereinafter “Marchini”) discloses an amusement machine pusher mechanism in which pieces are randomly strewn on a surface and a reciprocating pusher device nudges the pieces towards and occasionally over an edge of the surface, and the pushed-off pieces are won by the player. However, like Jordan, Marchini does not disclose anything related to an automatic coin counter, nor a gaming machine with music.

Therefore, there remains a need for a new and improved gaming machine that is capable of playing music according to the player's preferences and registering the player's profits in real time.

### SUMMARY OF THE INVENTION

It is an object of the present invention to provide a gaming apparatus that is capable of counting coins automatically and playing music according to the player's preferences.

It is another object of the present invention to provide a medal game apparatus that is referred to as a “coin pusher”, interfaced with an electronic game of chance.

It is a further object of the present invention to provide a gaming apparatus that can be used as a jukebox, wherein the player can enjoy the music while playing the game, and the gaming apparatus can play music according to the player's preferences by retrieving such information through the player's social networking website, such as Facebook, Yelp, etc.

In one aspect of the present invention, a folding chair may include an upper frame, two armrests, two side frames, a front linking unit and a rear linking unit. In one embodiment, the upper frame and the side frames are coupled through a plurality of connectors. More particularly, one end of the connector is fixed at the side frames and the other end is pivotally connected with the upper frame, so that the upper frame can move along a “z to x” direction (see FIG. 4) or vice versa on top of the side frames. The armrests are also coupled with the side frames through a plurality of armrest connectors. In one embodiment, two front armrest connectors are disposed at front portions of the side frames to engage two front ends of the armrests, while two rear armrest connectors are disposed at rear portions of the side frames to engage two rear ends of the armrests. Also, the armrests are pivotally connected with the side frames, so that the armrests can move along a “z to y” direction (see FIG. 4) or vice versa. In another embodiment, the upper frame and an upper portion of the side frames are covered by a fabric, which is provided as a backrest on the upper frame and a seat on the upper portion of the side frames.

In one embodiment, an electromechanical apparatus, such as and without limitation an arcade game, a pinball machine, and the like (collectively a “redemption game”), in combination with an electronic game is presented. The electronic game comprises a processor, a memory in communication with the processor, microcode encoded in the memory, wherein the processor utilizes the microcode to operate the apparatus, instructions written to the memory, wherein the instructions encode a game of chance, a visual display device in communication with the processor, wherein the processor can utilize the instructions to display results of the game of chance on the visual display device.

In another embodiment, an entertainment game comprising a redemption game, an electronic game integrated with said redemption game, a processor, a memory in communication with the processor, microcode encoded in the memory, wherein the processor utilizes the microcode to operate the entertainment game, instructions written to memory, wherein said instructions encode a game of chance, and a visual display device in communication with the processor, wherein the processor can utilize the instruction to display results of the game of chance on the visual display device.

In yet another embodiment, an entertainment game for providing a game of chance at a point of sale is presented. The entertainment game comprises a redemption game disposed within the entertainment game, an electronic game integrated with said redemption game, a processor, a memory in communication with the processor, microcode encoded in the memory, wherein the processor utilizes the microcode to operate the entertainment game, instructions written to memory, wherein said instructions encode a game of chance, and wherein said instructions encode a visual display of the redemption game, and a visual display device in communication with the processor, wherein the processor can utilize the instruction to display results of the game of chance on the visual display device, and wherein the processor can utilize the instructions to continuously display the course of the redemption game on the visual display.

In yet another embodiment, the entertainment gaming apparatus has a music playing unit that provides songs for the players to select. In one embodiment, the player receives a free promotion game when purchasing at least one song. In a further embodiment, the entertainment gaming apparatus is connected to a communication network to search and retrieve songs from various music content providers. In still a further embodiment, the entertainment gaming apparatus can provide a list of songs according to the player's preferences.

In yet another embodiment, a method to promote the sale of a product using the entertainment game is presented. The method comprises the steps of purchasing by a buyer a participating product, activating the game of chance encoded in Applicant's entertainment game, and communicating the results of that game of chance to the buyer.

### BRIEF DESCRIPTION OF THE DRAWINGS

FIG. 1A block diagram showing one embodiment of Applicant's apparatus.

FIG. 1B illustrates the apparatus of FIG. 1A in communication with an external computing device.

FIG. 2A is a block diagram showing a second embodiment of Applicant's apparatus.

FIG. 2B illustrates the apparatus of FIG. 2A in wireless communication with an external computing device.

FIG. 3A illustrates the elements of one embodiment of a “coin pusher”amusement game interfaced with an electronic game of chance.

FIG. 3B illustrates the exterior of the apparatus of FIG. 3A.

FIG. 4A illustrates the elements of a second embodiment of a “coin pusher” amusement game interfaced with an electronic game of chance.

FIG. 4B illustrates the exterior of the apparatus of FIG. 4A.

FIG. 5 is a flow chart summarizing certain steps in Applicants' method.

FIG. 6A illustrates a jukebox gaming apparatus that enables the player to listen to music while enjoying the game.

FIG. 6B illustrates a jukebox gaming apparatus that is able to connect to a communication network to search and retrieve music contents from several different sources.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In certain embodiments, Applicant's invention comprises an entertainment apparatus comprising an arcade game in combination with an electronic game encoding a game of chance. By “arcade game,” Applicant means a money-operated entertainment machine that requires on-going player input in order to sustain the play period of an individual game. Those skilled in the art will appreciate that arcade games often have very short play levels/times, simple and intuitive control schemes, and rapidly increasing difficulty. Redemption games are typically arcade games that reward the player proportionally to their score in the game. The reward most often comes in the form of tickets, with more tickets being awarded for higher scores. These tickets can then be redeemed (hence the name) at a central location for prizes.

For purposes of illustration but not of limitation, arcade games include pinball machines, medal games, ring toss, SPACE INVADERS, GALAXIAN, PAC-MAN, BATTLEZONE, DONKEY KONG, and the like.

In some embodiments, the redemption game is a medal game, also called a coin pusher game. As will be understood by one of ordinary skill in the art, in order to play a medal game a player must first exchange their money into medals. In some embodiments, the medal is a medal token. In other embodiments, the medal is a currency of a specific denomination, such as a United States quarter.

As will be understood by one of ordinary skill in the art, medal games are characterized by multiple platforms, each filled with medals. Behind the platforms are devices, such as brooms, which push the medals forward. When a player drops a new medal in, it falls onto one of the platforms. When the device next pushes the medal forward, the new medal may knock some of the medals off the edge of the platform and into a dispenser portion that returns those medals to the player. In certain embodiments, Applicant's medal game prints a ticket reciting certain awards, such as and without limitation prizes, money, merchandise, and the like. In other embodiments, Applicant's medal game awards points to a player's debit card.

In some embodiments, the medal game may include an interface. In some embodiments that may be a plinko-style interface. As will be known to one of ordinary skill in the art, with a plinko-style interface, when the player drops a new medal into the game, there are different slots the medal can fall into, causing various game effects. In some embodiments, a slot may cause one medal game to drop additional medals onto the platforms, thereby increasing the player's chances that some of the medal may be knocked off the edge and into the dispenser. In yet other embodiments, a coin slot or debit card slot may initiate an electronic game interfaced with the medal drop.

Using prior art medal game assemblies, the player looks through one or more transparent wall portions and actually watches the medals being pushed on the platforms by the pusher device.

In certain embodiments, Applicants medal game comprises no visually transparent portions. Rather, one or more video cameras are disposed within the interior of the game apparatus. Those one or more video cameras transmit real time images of tie events occurring within the game apparatus. A monitor disposed on the exterior of the game apparatus displays in real time the results of the medal drop game. In another embodiments, the player observes a computerized version of the medal drop game.

In yet another embodiment the redemption game is a merchandiser. As will be understood by one of ordinary skill in the art, a merchandiser is a type of game which displays a prize or prizes which can be won by the player using skill. In one embodiment, the player may guide a claw in an attempt to pick up a prize and drop it in a hole where the player can redeem it.

In some embodiments, Applicant's arcade game apparatus comprises a processor that implements a game of chance encoded in the apparatus, a visual display device that displays the results of that game, and optionally an audio speaker assembly, wherein a game activator element of the arcade game signals the processor to initiate the game of chance when a certain play level and/or point level is achieved.

In certain embodiments, Applicant's method comprises purchasing one or more sessions on the arcade game, activating the game of chance encoded in the arcade game, and communicating the results of that game of chance to the player. In some embodiments, the purchase of a single arcade game session entitles a player to one activation of the game of chance. In certain embodiments, if a player purchases ten arcade game sessions, then the player is entitled to ten activations, or ten plays. In some embodiments, the purchase of a single arcade game session entitles a player to more than one activation of the game of chance, i.e., more than one play. For example, a purchase of a single coin pusher session entitles a buyer to three games of chance.

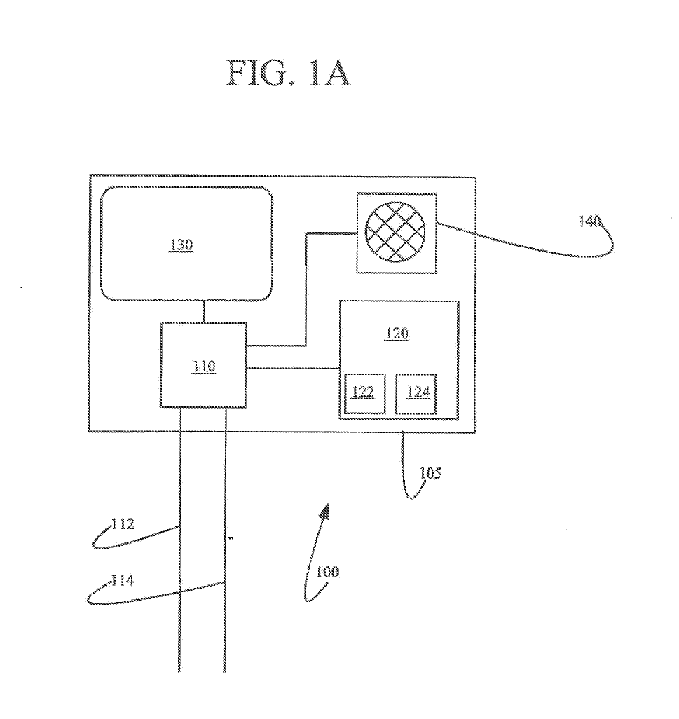

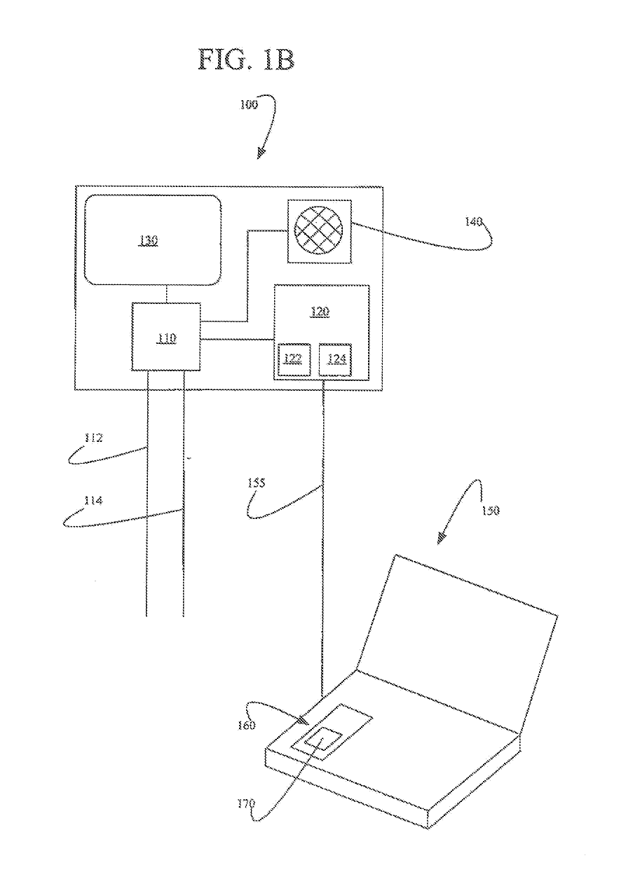

Referring now to FIG. 1A, Applicant's electronic game apparatus 100 (FIGS. 1A, 1B, 3, 4, 5) comprises a housing 105, a processor 110 disposed within housing 105, memory 120 disposed within housing 105, microcode 122 encoded in memory 120, and instructions 124 encoded in memory 120. Processor 110 utilizes microcode 122 to operate electronic game apparatus 100. Instructions 124 encode a game of chance.

In certain embodiments, processor 110, memory 120, microcode 122, and instructions 124 are disposed in an integrated device, such as and without limitation an application specific integrated circuit (“ASIC”). In certain embodiments processor 110, memory 120, microcode 122, and instructions 124, comprise Applicant's electronic game module. Applicant's electronic game module may include hardware circuits such as one or more processors with memory, Very Large Scale Integration (VLSI) circuits, gate arrays, programmable logic, and/or discrete components. The hardware circuits may perform hardwired logic functions, execute computer readable programs stored on tangible storage devices, and/or execute programmed functions. The computer readable programs may in combination with a computer system to perform the functions of the invention.

Communication links 112 and 114 are in interconnected with processor 110, and provide an interface between Applicant's apparatus and an electronic apparatus and/or mechanical device (collectively an “electromechanical device”), such as an arcade game. Communication links 122 and 124 may utilize any input output (“I/O”) protocol, such as and without limitation a wireless protocol, a serial interconnection, such as RS-232 or RS-422, an ethernet interconnection, a SCSI interconnection, an iSCSI interconnection, a Gigabit Ethernet interconnection, a Bluetooth interconnection, a Fibre Channel interconnection, an ESCON interconnection, a FICON interconnection, a Local Area Network (LAN), a private Wide Area Network (WAN), a public wide area network, Storage Area Network (SAN), Transmission Control Protocol/Internet Protocol (TCP/IP), the Internet, and combinations thereof.

In the illustrated embodiment of FIG. 1B, computing device 150 is shown in communication with memory 120 via I/O protocol 155. Instructions 170 encoded in memory 160 disposed on computing device 150 can be downloaded to memory 120 in Applicant's electronic game apparatus 100 (FIGS. 1A, 1B, 3, 4, 5). In certain embodiments, instructions 170 comprises an upgraded version of the game encoded by instructions 124.

In certain embodiments, instructions 124 comprise a cycle counter and a maximum cycle count. Each time processor 110 utilizes instructions 124 to display the encoded game of chance, the cycle counter is incremented by unity, i.e. by 1. When the cycle count equals the maximum cycle count processor 110 can no longer utilize instructions 124 to display the game of chance on the visual display device. In these cycle-limited embodiments, instructions 170 encode the same game as do instructions 124, however instructions 170 comprise a cycle counter set to 0.

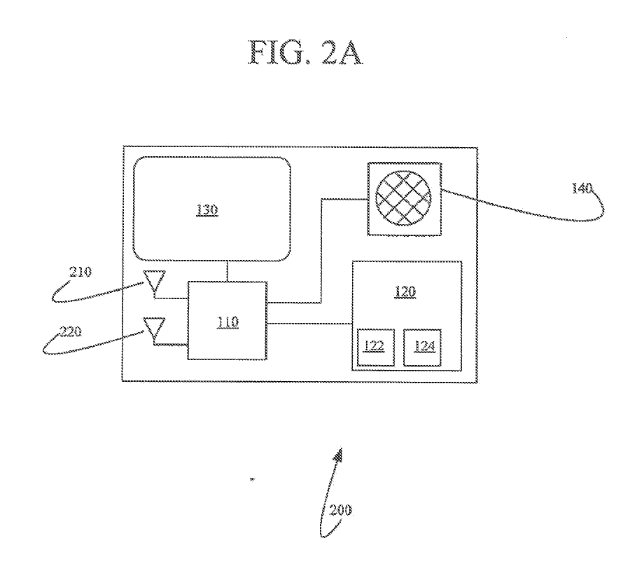

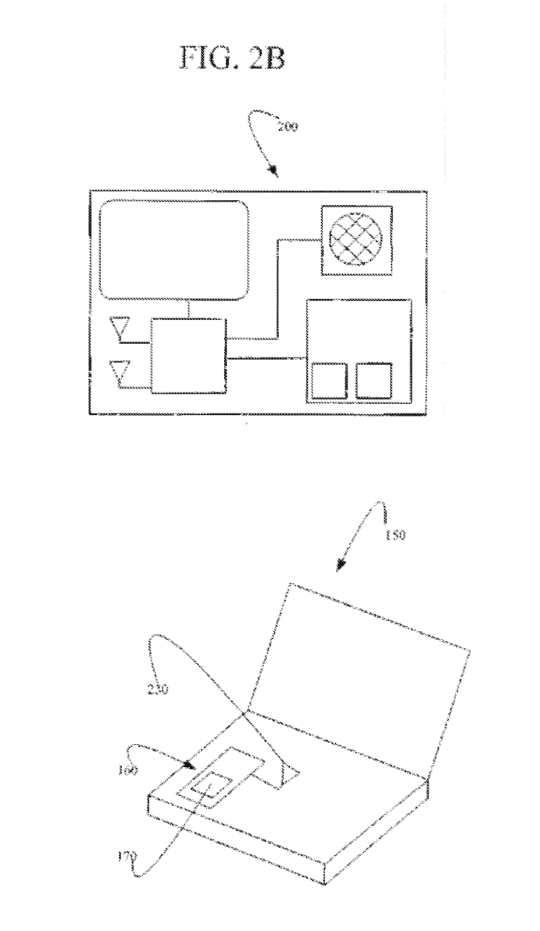

Referring now to FIG. 2A, Applicant's electronic game apparatus 100 (FIGS. 2A, 2B, 3, 4, 5) comprises the elements of Applicant's electronic game apparatus 100 FIGS. 1A, 1B, 3, 4, 5) in addition to first wireless communication hardware 210 in combination with complimentary firmware and software encoded in processor 110 and/or memory 120. In the illustrated embodiment of FIG. 2A, Applicant's electronic game apparatus 100 optionally further comprises second wireless communication hardware 220 in combination with complimentary firmware and software encoded in processor 110 and/or memory 120. In certain embodiments, the first wireless communication hardware, firmware, and software utilizes and implements Blue Tooth wireless communication. In certain embodiments, the second wireless communication hardware, firmware, and software utilizes and implements “WI-FI” wireless communication. In the illustrated embodiment of FIG. 2B, computing device 150 is shown downloading instructions 170 to Applicant's electronic game apparatus 100 (FIGS. 2A, 2B, 3, 4, 5) wirelessly.

In certain embodiments, Applicant's first wireless protocol and/or second wireless protocol are compliant with one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for Applicant's electronic game apparatus 100 (FIGS. 1A, 1B, 3, 4, 5) or 200 (FIGS. 2A, 2B, 3, 4, 5), and a wirelessly interfaced electromechanical device. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or Wi-Fi, which comprises an extension to 802.11 that applies to wireless LANS and provides up to about 11 Mbps transmission in the 2.4 GHz band; and/or (iv) specification 802.11g which applies to wireless LANs and provides 20+ Mbps in the 2.4 GHz band.

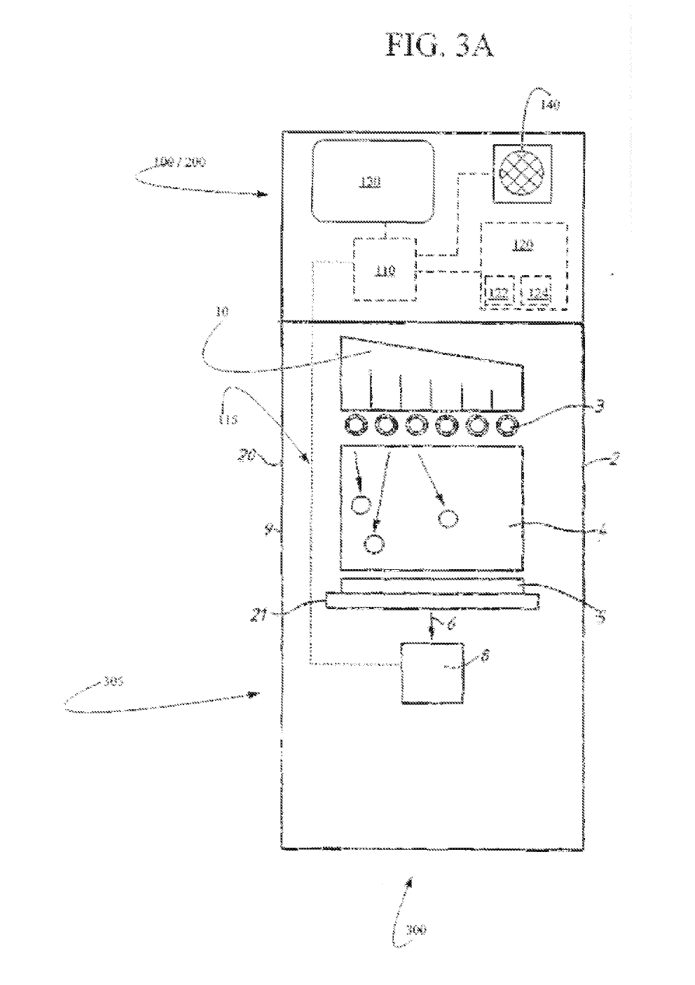

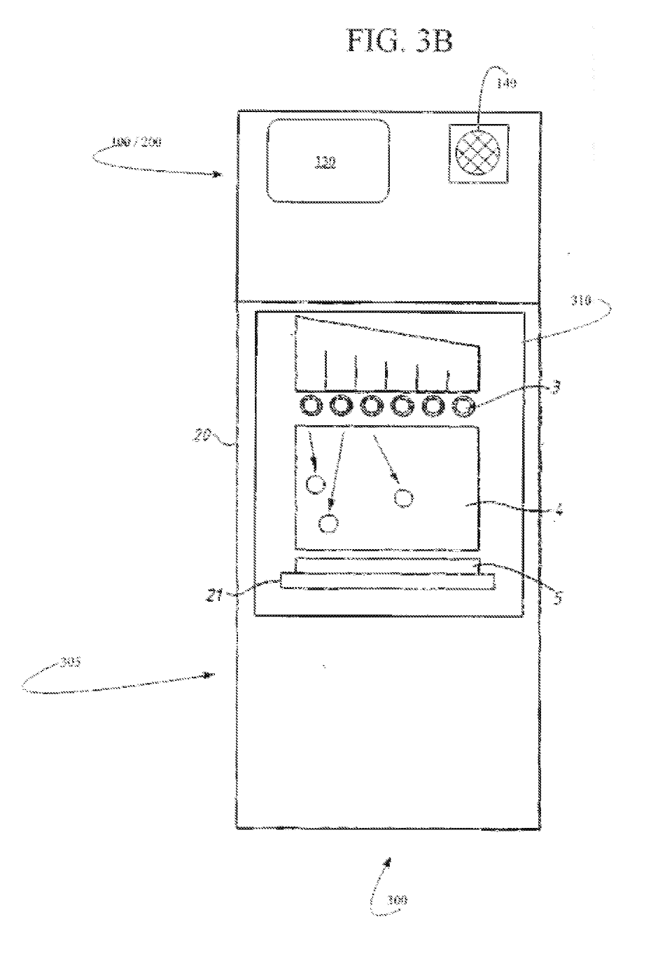

In certain embodiments, Applicant's electronic game apparatus 100 or 200 is interfaced with a “coin pusher” arcade game. Referring first to FIG. 3A, Applicant's coin pusher is housed in a cabinet 20. A playfield 21 provides a flat, horizontal upper surface on which a large number of coins (not shown) is distributed. A coin pusher 5 is in the form of a stage or box or broom which continuously moves backwards and forwards across at least part of the playfield surface. Coins on the playfield surface are thus pushed towards a front edge, and towards side edges of the playfield surface 21. At each side edge there is a “lose” chute which may be adjusted in size by the operator of the machine. At the front edge there is a “win” chute 6, through which coins pass after being pushed over the front edge. Coins which pass down the win chute 6 are received by a counting hopper 8. This includes conventional means for counting the coins received and generating an electronic signal which is proportionate to the number of coins counted. In another embodiment, the hopper 8 may kick out all the coins and register the amount into a digital or mechanical meter (not shown) to check the amount of profit, so the player does not have to count the coin one by one.

In certain embodiments, a player inserts a coin into apparatus 300, that coin is then lifted upwardly, and the coin then falls onto the pay field. In the illustrated embodiment of FIG. 3, a coin holder/dispenser unit 10 is disposed above the playfield, and holds a store of coins arranged in several stacks. Each stack is provided with a respective coin release button 3 operable by the player. When a coin release button 3 is actuated, a coin is released from the respective stack. This coin then falls through a pin PERSPEX member 4 and onto the playfield surface, either directly or via an upper surface of the pusher box. The pin PERSPEX member 4 comprises two sheets of visually transparent material placed face-to-face, and spaced apart with a gap just slightly greater than the thickness of a coin. In certain embodiments, a random arrangement of metallic pins connects the two sheets. Coins can thus fall down between the sheets, and optionally bounce off the metallic pins on the way down. This introduces an element of randomness in the passage of coins from the dispenser 10 to the playfield. The player is able to operate the machine by inserting coins, by other payment means such as bank notes, credit cards, pre-paid debit cards, or the machine may even be arranged for “free play.”

The illustrated embodiment of FIG. 3A is provided for illustration purposes, not by way of limitation. Those skilled in the art will appreciate, that other embodiments of coin pusher arcade games exist, and could be similarly interfaced with Applicant's electronic game apparatus 100/200.

FIG. 3B illustrates the exterior of Applicant's apparatus 300. Housing 20 is formed to include aperture 310 extending therethrough. Aperture 310 is covered by one or more layers of a visually transparent material. In certain embodiments, that visually transparent material comprises glass. In certain embodiments, that visually transparent material comprises polycarbonate. As a general matter, aperture 310 can be covered using one or more sheets of any visually transparent material.

A player using apparatus 300 sees video display 130 and speaker 140 disposed on the exterior of housing 20. A player further observes through aperture 310, a plurality of coins disposed in coin stacks 10, a plurality of coin release buttons 3, play field 21, and pusher 5. As the game progresses, the number of coins that fall through “win” chute 6 is displayed on video display 130. As the conclusion of the coin pusher session, processor 110 automatically executes one or more iterations of the game of chance encoded in instructions 124. The results of each iteration are displayed on video display 130. The number of game of chance iterations awarded are based upon the number of coins successfully delivered into repository 8.

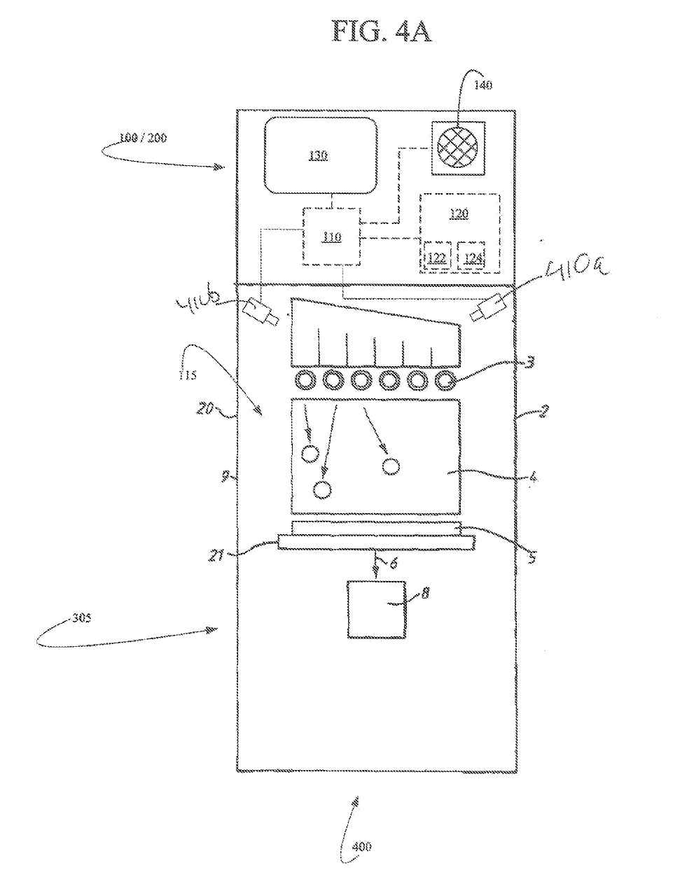

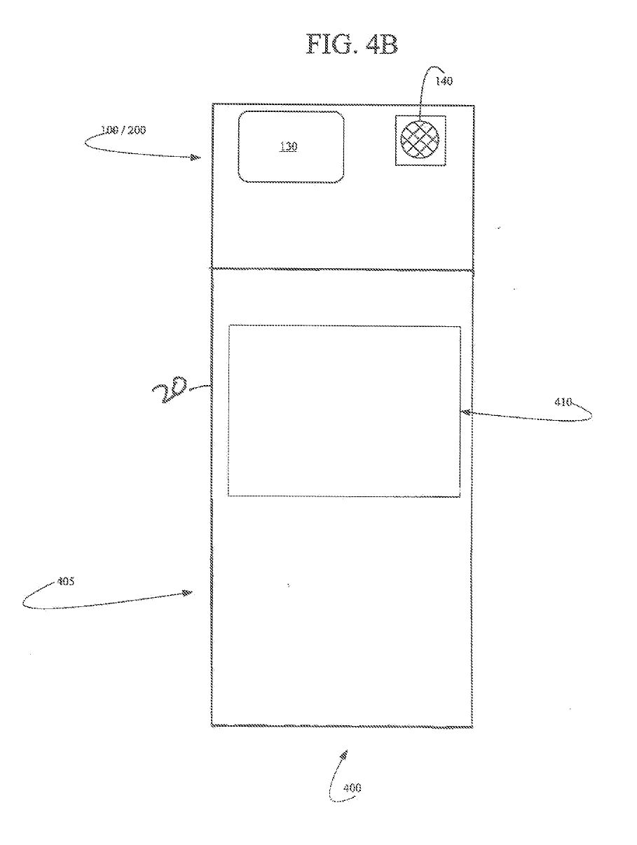

FIG. 4A illustrates the elements of embodiment 400 of Applicant's coin pusher apparatus. Coin Pusher apparatus 400 comprises all the elements of Applicant's coin pusher apparatus 300, and further comprises one or more video cameras 410. In the illustrated embodiment of FIG. 4A, apparatus 400 comprises video camera 410a and video camera 410b. Video camera 410a and 410b are in communication with processor 110.

Referring now to FIG. 4B, a player using apparatus 400 sees video display 130, speaker 140, and video display 410 disposed on the exterior of housing 20. Video display 41 0 is in communication with processor 110. As the one or more video cameras 410 provide video signals to processor 110, that processor 110 provides a video signal to video display device 410, such that video display 410 displays in real time the events taking place within housing 20.

In certain embodiments, Applicant's apparatus 300 and/or 400 is sold to restaurants, clubs, hotels, and video arcade owners. In certain embodiments, Applicant's apparatus 300 and/or 400 is leased by restaurants, clubs, hotels, and video arcade owners.

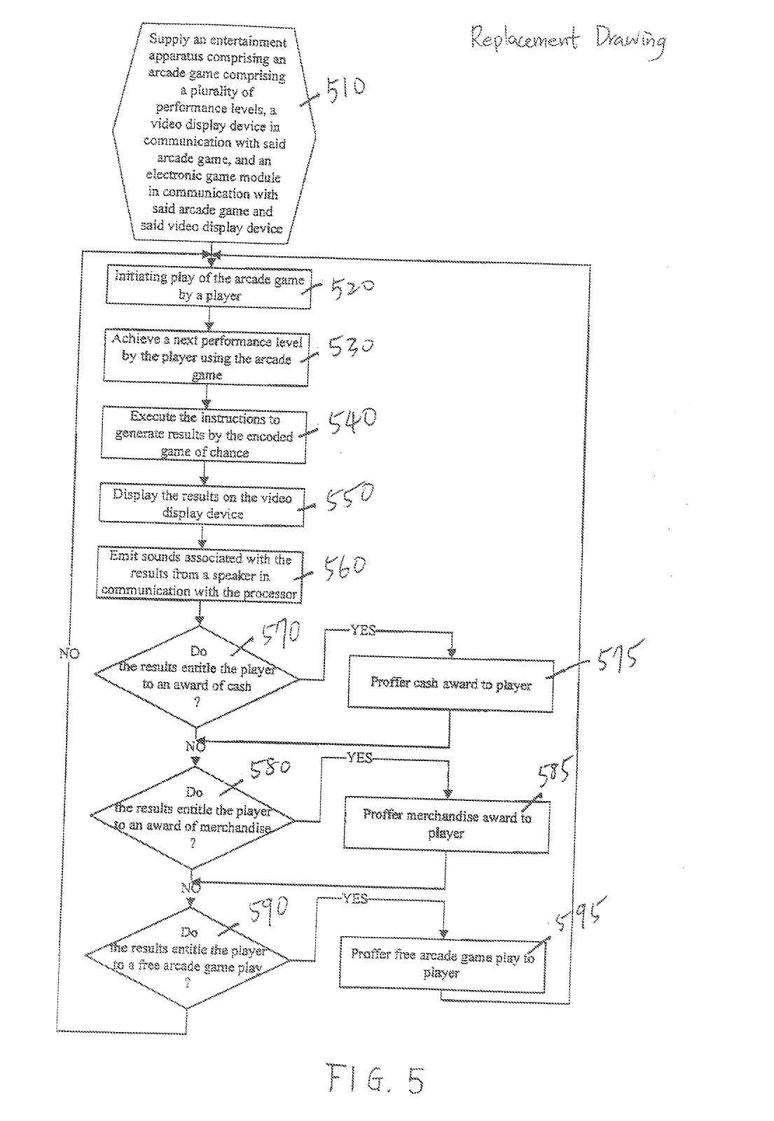

Applicant's invention includes a method using Applicant's entertainment apparatus. FIG. 5 summarizes the steps of Applicant's method. Referring now to FIG. 5 in step 510 the method provides Applicant's entertainment apparatus comprises an arcade game comprising a plurality of performance levels, a video display device in communication with the arcade game, and an electronic game module in communication with both the video display device and the arcade game.

In step 520, a player initiates play of the arcade game. In certain embodiments, step 520 comprises proffering money to the entertainment apparatus of step 510. In certain embodiments, step 520 comprises inserting a valid a credit card/debit card into the entertainment apparatus of step 510. In certain embodiments, step 520 comprises proffering a free game award to the entertainment apparatus of step 510.

In step 530, the player achieves a next higher performance level while playing the arcade game of step 510. In step 540, the method executes instructions encoded in a computer readable medium disposed in the electronic game module of step 510. In certain embodiments, a processor disposed in the electronic game module of step 510 receives a signal from the arcade game, and in response to that signal executes the instructions, wherein the instructions encode a game of chance.

In step 550, the method displays results generated by the game of change of step 520. In certain embodiments, Applicant's method includes step 560 wherein the method causes certain sounds to be emitted from a speaker in communication with the processor.

In step 570 the method determines if the results entitle the player to an award of cash. In certain embodiments, such an award of cash is displayed on the video display device. If the method determines in the step 570 that the results entitled the player to an award of cash, then the method transitions from step 570 to step 575 wherein the method proffers a cash award to the player. The method transitions from step 575 to step 580.

If the method determines in step 570 that the results do not entitle the player to an award of cash, then the method transitions from step 570 to step 580 wherein the method determines if the results entitle the player to an award of merchandise. If the method determines in the step 580 that the results do entitle the player to an award of merchandise, then the method transitions from step 580 to step 585 wherein the method proffers a merchandise award to the player. The method transitions from step 585 to step 590.

If the method determines in step 580 that the results do not entitle the player to an award of merchandise, then the method transitions from step 580 to step 590 wherein the method determines if the results entitle the player to a free play of the arcade game. If the method determines in the step 590 that the results do not entitle the player a free arcade game play, then the method transitions from step 590 to step 520 and continues as described herein. Alternatively, if the method determines in the step 590 that the results do entitle the player to an award of merchandise, then the method transitions from step 590 to step 595 wherein the method proffers a free arcade game play to the player. The method transitions from step 595 to step 520 and continues as described herein.

In certain embodiments, when playing Applicant's apparatus 300 or Applicant's apparatus 400, the game of chance encoded by instructions 124 comprises a card game. In certain embodiments, seven cards may be displayed on visual display device 130. In some embodiments, the faces of the cards are immediately shown on the monitor upon activation of the game. In some embodiments, the faces of the cards are not shown initially, but are subsequently revealed (simultaneously or sequentially) via, for example, an animated hand scratching off a layer covering the faces of the cards. In some embodiments, a winning hand from the seven cards game displayed on the monitor includes a royal flush, straight flush, four of a kind, full house, flush, straight, three of a kind, two pair, pair, or high card.

In certain embodiments, instructions, such as instructions 124 (FIGS. 2, 3) encoded in computer readable medium 120, are executed by a processor, such as processor 110 to perform one or more of steps 420, 430, 440, 450, 460, 470, and/or 480, recited in FIG. 4, and/or one or more of steps 510, 520, 530, 540, 550, and/or 560, recited in FIG. 5.

In some embodiments, the instructions 124 encode a game of chance programmed for playing a defined and limited number of games, and will payout a predetermined number of winning hands, with a predetermined amount of money for each winning hand. After the limited number of games has been played, instructions 124 must be replaced or reset. In certain embodiments, instructions the resetting may be achieved via, for example, replacing the expired game program board with a new one.

In some embodiments, the game is an instant sweepstakes game, e.g., instant sweepstakes point of sale game. In some embodiments, the apparatus for providing a game of chance functions as a cash register that is programmed for playing a 100,000 Texas Hold 'Em seven card games. In some embodiments, the predetermined winning hands and predetermined amount of money for each winning hand is shown below:
1. Royal Flush:

The best possible hand: Ace, King, Queen, Jack and 10 of the same suit (ex: A.diamond-solid., K.diamond-solid., Q.diamond-solid., J.diamond-solid., T.diamond-solid., 2, 4,) (five winners will be awarded $1,000 each) Total $5,000;
2. Straight Flush:

Any five-card sequence in the same suit (ex. 8, 9, T, J, Q, A.diamond-solid., K.diamond-solid.) (twenty winners will be awarded $500 each) Total $10,000;
3. Four of a Kind:

All four cards of the same value (ex. 8.diamond-solid., 8, 8, 8, A.diamond-solid., J and Q) (twenty winners will be awarded $125 each) Total $2500;
4. Full House:

Three of a kind combined with a pair (ex. T, T.diamond-solid., T with 6, 6.diamond-solid., J and Q) (sixty winners will be awarded $100 each) Total $6,000;
5. Flush:

Any five non-sequential cards of the same suit (ex. 2, 4, 5, 7, and T, A.diamond-solid., K.diamond-solid.) (sixty winners will be awarded $50 each) Total $3,000;
6. Straight:

Five cards in sequence, but not in the same suit (ex. 7, 8, 9.diamond-solid., T, and J, A.diamond-solid., K.diamond-solid.) (Eighty winners will be awarded $25 each) Total $2,000;
7. Three of a Kind:

Three cards of the same value (ex. J, J, J, 7, 8, 9.diamond-solid., 3.diamond-solid.) (five hundred winners will be awarded $10 each) Total $5,000;
8. Two Pair:

Two separate pairs (ex. 3.diamond-solid., 3, and Q, Q.diamond-solid., 8, 9, T) (Two Thousand winners will be awarded $5 each) Total $10,000;
9. Pair:

Two cards of the same value (ex. 7, 7.diamond-solid., K.diamond-solid., Q.diamond-solid., J.diamond-solid., 8, 2) (five thousand winners will be awarded $2 each) Total $10,000;
10. High Card:

If a hand contains none of the above combinations, it's valued by the highest card in it. (A.diamond-solid., K.diamond-solid., Q.diamond-solid., J.diamond-solid., 2, 4, 5,) THE ACE IS HIGH CARD (two thousand five hundred winners will be awarded $1 each) Total $2,500. The ace of spades is always the high card.

In other embodiments, instructions 124 encode one or more other games of chance, wherein instructions 124 cause various graphics to be displayed on video display 130, and/or cause sounds to be emitted from speaker 140.

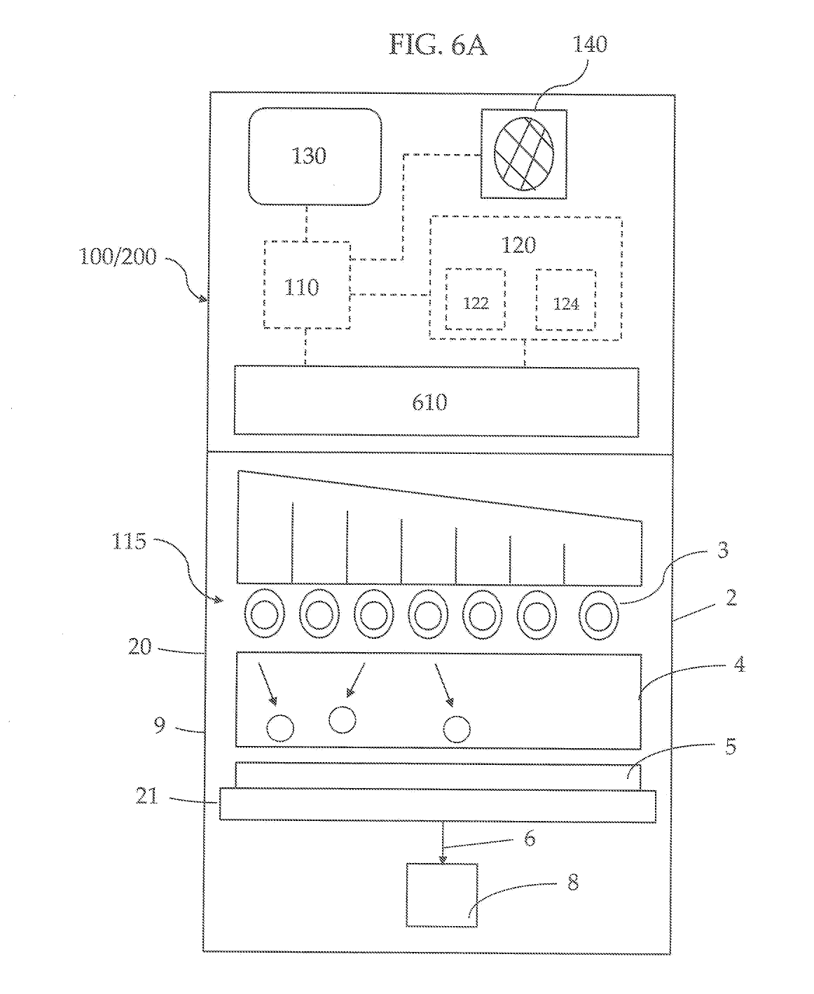

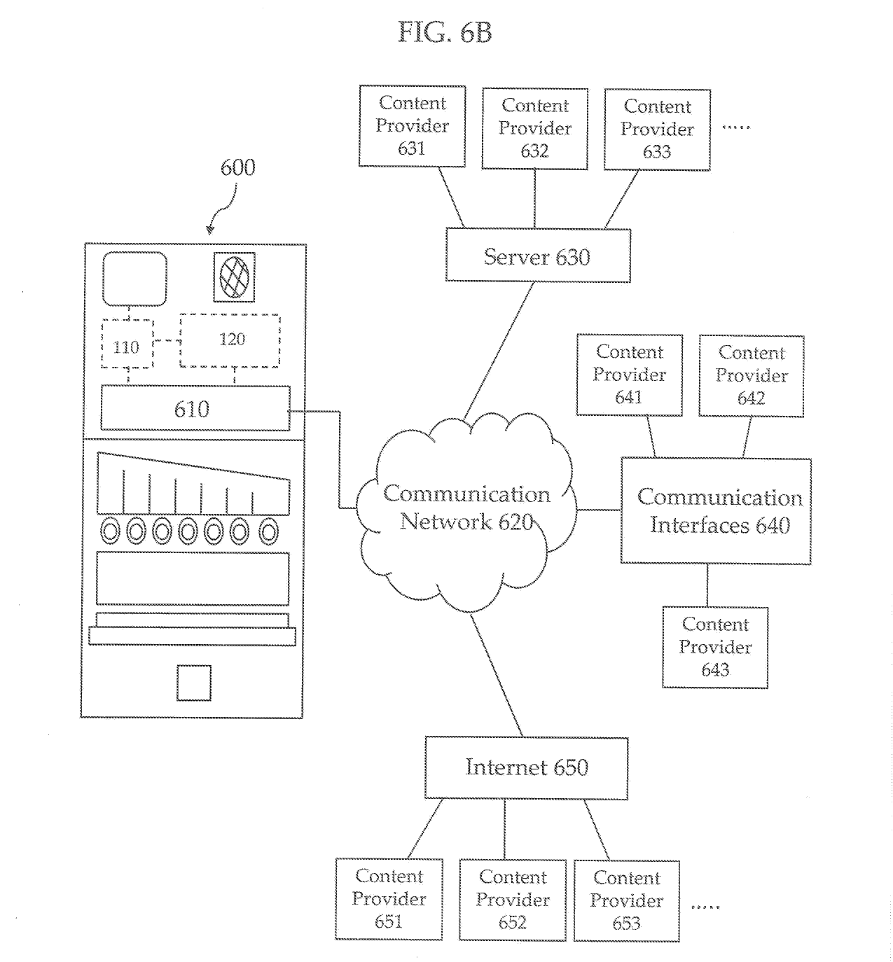

As shown in FIG. 6, a jukebox gaming apparatus 600 may include a music playing unit 610 and the electronic game apparatus 100/200. Like traditional jukeboxes, the player inserts a coin to the jukebox gaming apparatus 600 to receive a credit to purchase a song that is stored in at least one music database in the gaming apparatus 600, and each credit entitles the player to one song. The video display 130 can be used to display the number of credits remaining for the player to purchase songs. The video display 130 can also be used to provide a song selection list, so the user can select song(s) therefrom. After selecting the song, the player can continue to play the game on the gaming apparatus 600 while enjoying the music.

In one embodiment, a free game promotion is given to the player who purchases at least one song from the jukebox gaming apparatus 600 (so called “sweepstakes”). No additional purchase is necessary to play the free promotional game. The music playing unit 610 is also connected to the processor 110 that is used to manage the free promotional game when the player purchases the music.

Unlike a tradition coin-pusher machine, the player of the free game promotion controls the location of the coin drop and the skill setting of the game. The free game promotion allows the consumer to move the coin entry left and right, and if the “stop” button is pressed, the pusher will stop moving. After a coin is inserted, the coin drops down on the pusher, and the consumer is entitled to receive any winning coins that drop down.

In a further embodiment, the free game promotion does not set any predetermined odds. In other words, the processor 110 does not utilize instructions 124 to control the free game promotion. The amount of coins won by the player is purely based on the skill level of the player.

Even though the jukebox gaming apparatus 600 can provide a great number of songs for the players to select, the players may sometimes fail to find the song(s) or the type of song (s) they like. In one embodiment shown in FIG. 6B, the jukebox gaming apparatus 600 can be connected to a communication network 620 through which the music can be transmitted to the music playing unit 610 of the gaming apparatus 600. More specifically, for example, at least one content provider (631, 632 or 633) may stream the music to a server 630, and the gaming apparatus 600 may search for and receive the music from the server 630 via the communication network 620. Likewise, the gaming apparatus 600 can obtain music from at least one content provider (651, 652 or 653) through Internet 650 via the communication network 620. Similar content delivery scheme can be applied to other communication interfaces 640 linking to content providers 641 to 643. Thus, the music playing unit 610 of the gaming apparatus 600 can provide the players much more selections of music through many music content providers connected to the gaming apparatus 600 through the communication network 620.

In a further embodiment, the music playing unit 610 may provide a list of songs according to the player's preferences. For example, when the player insert a coin to purchase a song from the gaming apparatus 600, he/she may be asked to further provide an identification card, or the player can purchase the song by his/her credit cards. With the information retrieved from the identification card or credit card, the gaming apparatus 600 may be able to search the player's social networking websites (such as Facebook, Yelp, Linkedin, etc.) through the communication network 620 to further determine the player's preference about music. If the gaming apparatus 600 has the songs that the player likes, the music playing unit 610 can play the music. On the other hand, if the gaming apparatus 600 does not have the songs according to the player's preference, the gaming apparatus 600 can connect to various music content providers to search and retrieve the music as stated above.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An entertainment apparatus, comprising:
an arcade game;
a video display device in communication with said arcade game;
an electronic game module in communication with said video display device and, comprising:
a processor;
a computer readable medium in communication with said processor;
microcode encoded in said computer readable medium, wherein said processor utilizes said microcode to operate said game module;
instructions written to said computer readable medium, wherein said instructions encode a game of chance; and wherein said processor utilizes said instructions to display results of said game of chance on said visual display device, wherein said instructions comprise a cycle counter initially set to zero and a maximum cycle count; every time said processor utilizes said instructions to display said game of chance said cycle counter is incremented by unity; and when said cycle count equals said maximum cycle count said processor cannot utilize said instructions to execute said game of chance; and
a music playing unit that is used to play music from either at least one music database in the entertainment apparatus or a communication network that is connected to a plurality of music content sources.

2. The entertainment apparatus of claim 1, further comprising a speaker, wherein said speaker is in communication with said processor.

3. The entertainment apparatus of claim 1, further comprising a housing, wherein said processor and said computer readable medium are disposed within said housing; and said visual display device is disposed on an outer surface of said housing.

4. The entertainment apparatus of claim 1, wherein said processor, said processor, said computer readable memory, said microcode, and said instructions, are embodied in an application specific integrated circuit.

5. The entertainment apparatus of claim 1, wherein said arcade game comprises a medal game.

6. The entertainment apparatus of claim 5, wherein said game of chance comprises a card game.

7. The entertainment apparatus of claim 1, wherein the gaming apparatus is able to search a player's social networking websites (such as Facebook, Yelp, Linkedin, etc.) through the communication network to further determine the player's preference about music, and retrieve the music from the music database in the entertainment apparatus or the communication network that is connected to a plurality of music content sources.

8. The entertainment apparatus of claim 6, wherein the gaming apparatus is able to search a player's social networking websites (such as Facebook, Yelp, Linkedin, etc.) through the communication network to further determine the player's preference about music, and retrieve the music from the music database in the entertainment apparatus or the communication network that is connected to a plurality of music content sources.

9. The entertainment apparatus of claim 1, wherein a player is entitled to a free promotion game after purchasing at least one song.

10. A method to promote the use of an arcade game, comprising:
providing an entertainment apparatus comprising an arcade game comprises a plurality of performance levels, a video display device in communication with said arcade game, and an electronic game module in communication with said video display device and comprising: a processor, a computer readable medium in communication with said processor, microcode encoded in said computer readable medium, instructions written to said computer readable medium, wherein said processor utilizes said microcode to operate said game module, and said instructions encode a game of chance, and wherein said instructions comprise a cycle counter initially set to zero and a maximum cycle count; every time said processor utilizes said instructions to display said game of chance said cycle counter is incremented by unity; and when said cycle count equals said maximum cycle count said processor cannot utilize said instructions to execute said game of chance;
initiating said arcade game by a user;
achieving a next performance level on said arcade game by said user;
executing said instructions by said processor to generate results from said game of chance;
displaying said results on said video display device; and
playing music from either at least one music database in the entertainment apparatus or a communication network that is connected to a plurality of music content sources.

11. The method to promote the use of an arcade game of claim 10, wherein said entertainment apparatus further comprises a speaker, further comprising emitting sounds from said speaker when displaying said results on said video display device.

12. The method to promote the use of an arcade game of claim 10, further comprising:
operative if said results entitle said player to an award of cash, proffering to said player said award of cash; and
operative if said results entitle said player to an award of merchandise, proffering to said player said award of merchandise.

13. The method to promote the use of an arcade game of claim 12, wherein said entertainment apparatus further comprises a housing, wherein said processor and said memory are disposed within said housing; and said visual display device is disposed on an exterior surface of said housing.

14. The method to promote the use of an arcade game of claim 13, wherein said processor, said memory, said microcode, and said instructions, are embodied in an application specific integrated circuit.

15. The method to promote the use of an arcade game of claim 9, wherein the step of playing music from either at least one music database in the entertainment apparatus or a communication network that is connected to a plurality of music content sources comprises steps of searching a player's social networking websites (such as Facebook, Yelp, Linkedin, etc.) through the communication network; determining the player's preference about music, and retrieving the music from the music database in the entertainment apparatus or the communication network that is connected to a plurality of music content sources.

16. The method to promote the use of an arcade game of claim 12, wherein the step of playing music from either at least one music database in the entertainment apparatus or a communication network that is connected to a plurality of music content sources comprises steps of searching a player's social networking websites (such as Facebook, Yelp, Linkedin, etc.) through the communication network; determining the player's preference about music, and retrieving the music from the music database in the entertainment apparatus or the communication network that is connected to a plurality of music content sources.

17. The method of promote the use of an arcade game of claim 10, further comprising a step of providing a free promotion game to a player who purchase at least one song.
